(19) United States
(12) Patent Application Publication
(10) Pub. No.: US 2026/0043907 A1
(43) Pub. Date: Feb. 12, 2026

(54) Method for Testing a Laser System

(71) Applicant: Robert Bosch GmbH, Stuttgart (DE)

(72) Inventors: Joern Hoffarth, Reutlingen (DE); David Copeto, Ludwigsburg (DE); Stefan Noe, Stuttgart (DE)

(21) Appl. No.: 19/289,572

(22) Filed: Aug. 4, 2025

(30) Foreign Application Priority Data
Aug. 7, 2024 (DE) 10 2024 207 470.5

(51) Int. Cl. G01S 7/497; G01S 7/4915; G01S 17/32

(52) U.S. Cl. CPC G01S 7/497; G01S 7/4915; G01S 17/32

(57) ABSTRACT

A method for testing a laser system includes defining at least one safety criterion, wherein the at least one safety criterion specifies a permissible range for controlling a laser of the laser system. The method further includes automated testing of the laser system on the basis of the defined at least one safety criterion. Also, the method includes initiating at least one action as a function of a result of the testing. The at least one safety criterion is selected from (i) a minimum and/or maximum value and/or a rate of change of a control variable of the control system, (ii) a minimum and/or maximum value and/or a rate of change of a manipulated variable of the control system, and (iii) a maximum settling time of the laser during a switch-on process. A computer program, a device, and a storage medium for this purpose are also disclosed.

This application claims priority under 35 U.S.C. § 119 to application no. DE 10 2024 207 470.5, filed on Aug. 7, 2024 in Germany, the disclosure of which is incorporated herein by reference in its entirety.

The disclosure relates to a method for testing a laser system. The disclosure further relates to a computer program, a device, and a storage medium for this purpose.

### BACKGROUND

Testing laser systems is crucial, especially with regard to user eye safety. Depending on its wavelength and intensity, laser radiation can pose significant health risks, particularly to the eyes, which are especially sensitive to intense light sources. An inadequately tested laser system can lead to unwanted exposure and thus to serious eye damage, including temporary or permanent visual impairment. In the event of component failure, the output power of the laser system can increase many times over. The higher the laser output, the faster the system must be switched off to ensure eye safety. It is therefore essential that laser systems are subjected to strict testing and safety protocols to ensure that they comply with applicable safety standards and provide a safe working environment for users.

### SUMMARY

The subject matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that a reciprocal reference is always possible with regard to the disclosure of the disclosure.

The subject matter of the disclosure is in particular a method for testing a laser system, comprising the following steps, wherein the steps can be repeated and/or performed in a certain order. The laser system may be a laser rangefinder.

The laser system can be used in a plurality of applications requiring precise measurements or control of laser beams. An example of this is a laser rangefinder that may be used for distance measurement. This device requires accurate control mechanisms to sense reliable distances. The method according to the disclosure can make the operation of this distance measuring device safer and more stable. The definable safety criteria of the method according to the disclosure can be specifically tailored to the requirements of a laser rangefinder in order to ensure optimum measurement accuracy and safety.

In a first step, at least one safety criterion is preferably defined, wherein the at least one safety criterion specifies a permissible range for controlling a laser of the laser system.

In a further step, the laser system is preferably tested automatically on the basis of the defined at least one safety criterion. The testing may comprise, for example, comparing a current value within the control system with a value according to the at least one safety criterion. Advantageously, a fault in the laser system can thus be detected at an early stage on the basis of at least one safety criterion.

In a further step, at least one measure is preferably initiated depending on the result of the testing. The at least one measure may comprise, for example, adjustments to the laser control, a warning message or a complete reduction of the output power of the laser system, depending on the result of the testing. It is also conceivable that the at least one measure does not comprise any action, so that operation continues unchanged if a result of the testing indicates that the laser system meets the at least one safety criterion. The at least one measure can be used to respond advantageously to a safety-critical state of the laser system.

It is also advantageous if at least one safety criterion is selected from:
a minimum and/or maximum value and/or a rate of change of a control variable of the control system,
a minimum and/or maximum value and/or a rate of change of a manipulated variable of the control system,
a maximum settling time of the laser during a switch-on process.

This has the advantage that the safety of the laser controller can be tested by way of a precise analysis of the control variable and manipulated variable as well as the rates of change and settling times. This allows finer adjustment to specific requirements and applications. The option of selecting from different safety criteria offers particular flexibility when configuring the laser system for different applications. Another safety criterion can be register overflows in a filter and/or an integrator of the laser system.

Preferably, the disclosure may provide that the method further comprises the following steps:
defining a checksum for a reference variable, control variable and/or manipulated variable of the control system,
comparing a current value of the reference variable, control variable and/or manipulated variable with the defined checksum.

The reference variable of the control system is, in particular, a predefined value that the control system aims to achieve. This reference variable can be selected so that it enables a desired behavior or performance of the laser system. By calculating the checksum for relevant control values, such as reference variable, control variable, and manipulated variable, additional error detection can be implemented. A comparison of the current value with the defined checksum enables, in particular, the identification of corruption or manipulation in transmitted data. This can contribute to the stability and safety of the laser system by enabling undesirable changes to be detected at an early stage and appropriate measures to be taken.

For example, it may be stipulated that the at least one safety criterion is only taken into account once the laser has reached a steady state. This ensures that the laser system is only tested during a stable operating phase. This has the advantage of avoiding unnecessary interventions during the laser's settling time.

It may further be possible for the at least one measure to comprise the following step:
initiating a transition of the laser system to a safety state, wherein in the safety state an emission of light by the laser is reduced to a level that is harmless to the human eye or is switched off.

This ensures, in particular, protection against potential damage caused by uncontrolled or misdirected laser emissions and can increase the safety of the laser system in the event of malfunctions.

According to a further advantage, it may be provided that the at least one measure comprises the following step:
saving the testing result.

In particular, the triggering safety criterion is stored and, preferably, all values used in the laser system at the time of triggering, such as the reference variable, control variable, manipulated variable, filtered intermediate results, integrator states, differentiator states, and/or operating modes, are also recorded. In this way, the result of the testing can be retrieved from the laser system at any time. This enables tracking and can facilitate error analysis in the event of a safety problem. The result can be stored in a register of the laser system, i.e., the corresponding values can be stored in one or more registers. This can reduce access to external storage media, which can shorten the response time for safety measures.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured so as to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution. The device may also be an analog discrete electronic circuit or an integrated electronic circuit that is appropriately configured to perform the method according to the disclosure.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium, and a computer program according to exemplary embodiments of the disclosure,

FIG. 2 a schematic illustration of a laser system according to exemplary embodiments of the disclosure.

### DETAILED DESCRIPTION

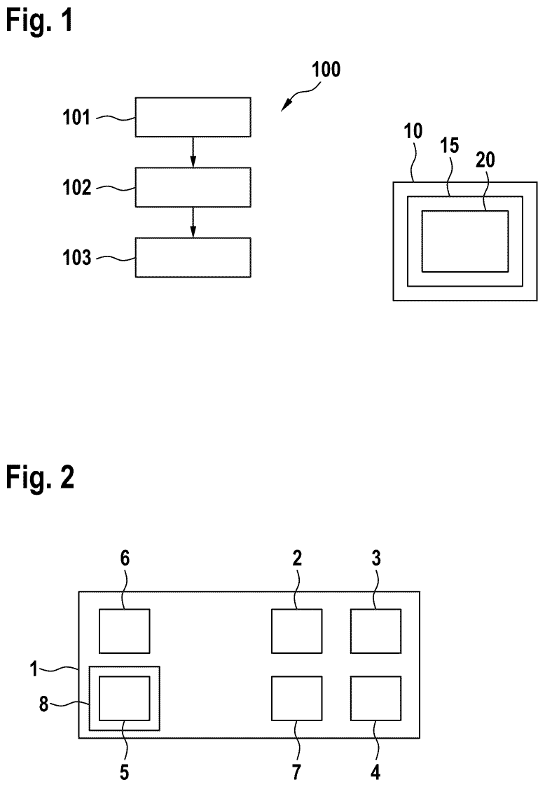

FIG. 1 schematically illustrates a method 100, a device 10, a storage medium 15, and a computer program 20 according to exemplary embodiments of the disclosure.

FIG. 1 shows in particular an exemplary embodiment of a method 100 for testing a laser system 1. In a first step 101, at least one safety criterion is defined, wherein the at least one safety criterion specifies a permissible range for controlling a laser 3 of the laser system 1. In a second step 102, the laser system 1 is preferably tested automatically on the basis of the defined at least one safety criterion. In a third step 103, at least one measure is initiated depending on the result of the testing. At least one safety criterion is selected from:
a minimum and/or maximum value and/or a rate of change of a control variable of the control system,
a minimum and/or maximum value and/or a rate of change of a manipulated variable of the control system,
a maximum settling time of the laser 3 during a switch-on process.
   Another safety criterion can be register overflows in a filter and/or an integrator of the laser system.

The method of the present disclosure relates to a laser system 1 and, according to exemplary embodiments, in particular to a laser rangefinder that uses indirect time of flight (iToF) measurement. For this exemplary embodiment, reference is made to FIG. 2. This laser rangefinder 1 operates, for example, by measuring a phase shift of a modulated light signal that is emitted by the laser rangefinder and reflected by a target object. The functionality of the indirect time of flight (iToF) measurement is described below. First, a laser 3, in particular a laser diode of the laser 3, can transmit intensity-modulated light in the laser rangefinder 1, for example in the infrared or visible area, towards a target object. Modulation takes place in particular with a sinusoidal or square wave. The intensity-modulated light subsequently strikes the target object and is reflected back to the laser rangefinder 1. A detector 4 in the rangefinder can now receive the reflected light. As the light needs a certain amount of time to travel the distance there and back, there is a phase shift between the emitted and received signal. This phase shift between the transmitted and received signal can then be measured. This phase shift is particularly proportional to the distance traveled by the light. The distance can then be calculated from the phase shift, taking into account the wavelength of the modulation and the speed of light. It may further be provided that a reference phase is determined with a second detector having a constant distance (not shown) to determine the phase shift based on a comparison to the reference phase.

The laser rangefinder 1 can have a measuring controller 2. The measuring controller 2 is responsible in particular for laser control, i.e., for example, control of the laser 3, modulation, signal processing, phase measurement, and/or data transmission.

Thus, the measurement controller 2 may control an emission of the laser 3 by controlling switching the power on and off, as well as controlling intensity and modulation of a laser beam of the laser 3. This ensures that the laser beam is emitted with the correct power and properties.

Upon receipt by the detector 4 of a fraction of the transmitted laser light, the measurement controller 2 may process the received signal. This comprises, for example, amplification, filtering and conversion of the received analog signal into a digital signal for further analysis, in particular by an analog-to-digital converter 5. Furthermore, the phase shift between the transmitted signal and the received signal may be measured and optionally compared to the reference phase.

The measurement controller 2 may also periodically perform calibrations to ensure that the measurements are precise. To do this, it can monitor the status of laser 3 and detector 4 to ensure that they are working properly.

In addition, the laser system 1, in particular the laser rangefinder, can comprise an analog-to-digital converter 5. The analog-to-digital converter 5 preferably converts analog signals received from the detector 4 into digital signals. In particular, these signals represent an intensity of light transmitted by the laser 3. The digital conversion may allow the phase shift between the transmitted signal and the received signal to be analyzed. The digital signals provided by the respective analog-to-digital converter 5 may be further filtered, amplified, and processed to reduce noise and improve signal quality.

In addition, the laser system 1 can comprise an application-specific integrated circuit 8 in which, for example, the analog-to-digital converter 5 can be located. The laser system 1 can also have a microcontroller 7 in order to check the defined safety criteria using the microcontroller 7. Furthermore, the laser system 1 can have at least one register 6 in order to store data in it, such as which of the defined safety criteria was not met in the event of a fault.

One advantage of the disclosure according to exemplary embodiments is, in particular, that basic safety can be ensured even if the microcontroller 7, or even a computer or control unit, crashes. In addition, in a redundant laser system 1, for example, the microcontroller 7 has to test the application-specific integrated circuit 8 less frequently. This can reduce the required computing load.

According to exemplary embodiments of the disclosure, minimum and/or maximum values as well as rates of change for a control variable of the laser control can be defined. Furthermore, minimum and/or maximum values as well as rates of change for a manipulated variable of the laser control can be defined. A maximum settling time can also be defined when laser 3 is switched on. Values such as a reference variable, manipulated variable and/or control variable can be compared against a checksum. Furthermore, a safety state can be defined to which the laser system 1 switches if an error occurs, i.e. if at least one defined safety criterion is not met. The defined values above can be ignored individually and temporarily until the laser 3 has settled.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for testing a laser system, comprising:
defining at least one safety criterion, wherein the at least one safety criterion specifies a permissible range for controlling a laser of the laser system;
performing automated testing of the laser system on the basis of the defined at least one safety criterion; and
initiating at least one action as a function of a result of the testing,
wherein the at least one safety criterion is selected from:
a minimum and/or maximum value and/or a rate of change of a control variable of the control system,
a minimum and/or maximum value and/or a rate of change of a manipulated variable of the control system, and
a maximum settling time of the laser during a switch-on process.

2. The method according to claim 1, further comprising:
defining a checksum for a reference variable, control variable and/or manipulated variable of the control system; and
comparing a current value of the reference variable, control variable and/or manipulated variable with the defined checksum.

3. The method according to claim 1, wherein the at least one safety criterion is only taken into account from a steady state of the laser.

4. The method according to claim 1, wherein the at least one measure comprises:
initiating a transition of the laser system to a safety state, wherein in the safety state an emission of light by the laser is reduced to a level that is harmless to the human eye or is switched off.

5. The method according to claim 1, wherein the at least one measure comprises:
saving the result of the testing in a register of the laser system.

6. The method according to claim 1, wherein the laser system is a laser rangefinder.

7. A computer program comprising instructions for causing the computer to carry out the method according to claim 1 when the computer program is executed by a computer.

8. A device for data processing, configured to carry out the method according to claim 1.

9. A computer-readable storage medium, comprising instructions which, when executed by a computer, cause said computer to carry out the steps of the method according to claim 1.
